(19) United States
(12) Patent Application Publication
(10) Pub. No.: US 2014/0190483 A1
(43) Pub. Date: Jul. 10, 2014

(54) Self-Contained Integrated Emergency Life-Support Device And System

(71) Applicants: Mark A. Hansen, Virginia Beach, VA (US); David A. Buck, Chesapeake, VA (US)

(72) Inventors: Mark A. Hansen, Virginia Beach, VA (US); David A. Buck, Chesapeake, VA (US)

(73) Assignee: CRITICAL SYSTEMS INNOVATIONS, INC., Chesapeake, VA (US)

(21) Appl. No.: 13/106,609

(22) Filed: May 12, 2011

Related U.S. Application Data
(60) Provisional application No. 61/344,038, filed on May 12, 2010.

(51) Int. Cl. A62B 7/02; A62B 18/02; A62B 23/02; A62B 7/10; A62B 7/12

(52) U.S. Cl. CPC A62B 7/02; A62B 7/10; A62B 7/12; A62B 23/025; A62B 18/02
USPC 128/205.12

(57) ABSTRACT

A self-contained respiratory protection system is disclosed. The system includes a center module attachable to one or more cylinders of air, gas or oxygen. A plurality of filters is mountable on the center module. A blower motor also may be mounted on the center module. A hose attaches to a cylinder to provide air to an operator or draws filtered air via the filters on the center module. A first stage regulator converts the air in the cylinder to breathable air for the operator. A second stage regulator transitions between filter mode and supplied air. The system may fit within a backpack.

### CROSS-REFERENCE TO RELATED APPLICATIONS

This application claims the benefit of priority under 35 U.S.C. §120 to U.S. Provisional Application Ser. No. 61/344,038, filed on May 12, 2010, the disclosure of which is incorporated by reference in its entirety.

### FIELD OF THE INVENTION

The present invention relates to a device and system to provide breathable air to a user under extreme conditions, such as chemical, biological, radiological or nuclear environments. More particularly, the present invention relates to a device and system to provide respiratory protection by allowing the user in an extreme environment to select one of several different configurations to receive air.

### BACKGROUND

Current respiratory protection systems suffer from the use of heavy and unwieldy components and configurations that are impractical. These systems are not intended for combat or other extreme operations or do not operate properly in modern chemical, biological, radiological or nuclear (CBRN) environments. Conventional respiratory protection systems have been designed for civil/fire service or hazardous materials operations. Some systems have been converted for combat or tactical law enforcement use with little or no modifications. While the current systems excel for their intended conventional use, these systems fail to provide the flexibility or configurations needed for a soldier, law enforcement officer or special operator in combat or tactical situations or in CBRN environments.

Various respiratory protection systems attempt to bridge the gap between civil/fire operations and special military operations, but these systems tend to be heavier and larger than their civil-use counterparts, without the ability to quickly and easily reconfigure the various components to meet the needs of any particular operation. For example: U.S. Pat. No. 7,543,584 is directed to a powered air purifying respirator and breathing system; U.S. Pat. No. 7,647,927 is directed to self-contained breathing system; U.S. Pat. No. 7,748,380 is directed to a combined air-supplying/air purifying system; and U.S. Pat. No. 7,380,551 is directed to a breathing apparatus; all of which are incorporated herein by reference in their entirety. Bulky respiratory protection systems inhibit a soldier, for example, in maneuvering through tight spaces or approaching opposing forces with stealth. A soldier, law enforcement officer or other special operator in a combat or tactical situation requires minimal additional weight and obstruction while trying to breathe.

Further, these systems require difficult and costly maintenance over time due to the complexity of their components and design. Adaptability to existing, or advanced, personal protective equipment and to emerging mission requirements is difficult because of the complexity of the systems.

Conversion of existing systems would prove costly and difficult. Maintenance of a variety of different systems also would be unmanageable as each mission-specific configuration would have different features and requirements. A soldier, law enforcement officer or other special operator may need to maintain three, four, or even more different respiratory protection system, depending on the situation. Thus, readiness and preparedness is compromised by retrofitting existing systems as well.

### SUMMARY

The embodiments of the present invention disclose a reliable, compact and more flexible respiratory protection system and device specifically intended for use in combat operations tactical law enforcement operations, intelligence operations, and CBRN environments. As opposed to current civil/fire use systems, the present invention operates in a tactical setting on both land and sea. Specifically, it meets the needs of the user adapt and succeed in a CBRN environment.

The disclosed embodiments employ a modular geometry designed to allow the user, such as for example, a Special Forces operator, tactical law enforcement officer, security or protective services officer, or other special operator, to select from several different respiratory protection formats and configurations. This modularity allows the disclosed embodiments to meet the unique demands of specific missions or operational environments without high maintenance costs or expensive retrofits to current systems.

According to the disclosed embodiments, a self-contained integrated life-support device is provided that allows an operator to select at least four modes of respiratory protection. These modes include a self-contained breathing apparatus (SCBA). Another mode may be a powered air purifying respirator (PAPR). Another mode may be an air purifying respirator (APR). Yet another mode may be a supplied air respirator (SAR). These modes and their corresponding configurations are disclosed in greater detail below.

Embodiments of the present invention are directed to a breathing apparatus including: one or more contained air cylinders connected to a supply manifold; a contained air supply hose; one or more air filters connected to a filtered air manifold; a blower motor connected to the filtered air manifold; a filtered air supply hose connected to the filtered air manifold; and an air supply assembly connected to both the contained air supply hose and the filtered air supply hose for delivery of pressurized contained air, filtered air, or powered filtered air.

Embodiments of the preset invention can include any one or more of the following features: pressurized air can be supplied on demand if the filtered air supply is reduced or compromised; the air supply assembly includes a regulator connected to the contained air supply hose; a high pressure regulator is in communication with the manifold; self-contained air is supplied to a second air supply assembly through the high pressure assembly; the air supply assembly is connected to a mask; and at least one of the cylinders can contain pure oxygen.

Yet another embodiment is directed to a breathing apparatus including: one or more contained air cylinders connected to a supply manifold; a contained air supply hose; one or more air filters connected to a filtered air manifold; a blower motor connected to the filtered air manifold; a filtered air supply hose connected to the filtered air manifold; an air supply assembly connected to both the contained air supply hose and the filtered air supply hose for delivery of pressurized contained air, filtered air, or powered filtered air; and a high pressure assembly including a high pressure input connection and a high pressure output connection, wherein the high pressure assembly is in communication with the manifold. The high pressure assembly can further include a high pressure input connection and a high pressure output connection, wherein the high pressure assembly is in fluid communication with the manifold. One or more contained air cylinders connected to the manifold, or all air cylinders connected to the manifold can be recharged with high pressure air through the high pressure assembly.

Still another embodiment is directed to a modular breathing apparatus including: a self-contained air module including one or more pressurized cylinders, a pressurized air supply hose, and a manifold connected to the one or more cylinders and the pressurized air supply hose; a filtered air module including one or more air filtration cartridges, a filtered air supply hose and a filtered air manifold connected to the one or more filtration cartridges and the filtered air supply hose; a powered air module comprising a blower motor connected to the filtered air manifold; and an air supply assembly for delivery of pressurized air and filtered air to a user including a regulator connected to the pressurized air supply hose and a filtered air supply connection.

In a further embodiment, the powered air module is replaced with a connection plug to provide only self-contained pressurized air or filtered air to the air supply assembly. In yet another embodiment one or more filtration cartridges are replaced with one or more connection plugs to provide only self-contained pressurized air to the air supply assembly.

Other embodiments of the present invention can include one or more of the following features: a high pressure regulator connected to the manifold and the pressurized air supply hose; a high pressure assembly including a high pressure input connection and a high pressure output connection, wherein the high pressure assembly is in fluid communication with the manifold; pressurized air is supplied on demand by the user during reduced availability of the filtered air through the filtered air supply hose.

A further embodiment of the present invention is directed to a method for providing air supply including: providing self-contained air through a pressurized air manifold and pressurized air supply hose; providing filtered air through a filtered air manifold and filtered air supply hose; providing powered filtered air through a blower motor connected to the filtered air supply manifold; switching between pressurized air and filtered air or powered filtered air wherein the switching is on demand by activation of a regulator upon reduced or obstructed filtered air or powered filtered air supply; and switching between pressurized air and filtered air is done by lung demand activation with a manual valve, or electrical switch.

Still another embodiment of the present invention is directed to a method of providing a modular breathing apparatus, including: providing a pressurized air manifold with one or more sealable supply connections and one or more pressurized cylinders connected to the sealable connections, wherein the connection is sealed with a cap when a cylinder is not connected thereto; providing a filtered air manifold with one or more sealable filter connections and one or more air filtration cartridge connected to the sealable filter connections, wherein the connection is sealed with a cap when a filtration cartridge is not connected thereto; providing a blower motor connected to the air manifold at one of the sealable filter connections; connecting a sealable mask to the pressurized air manifold wherein the connection includes one or more regulators; connecting the sealable mask to the filtered air manifold; and automatically switching between pressurized air supplied from the pressurized air manifold and the filtered air supplied from the filtered air manifold.

The various embodiments of the present invention may provide one or more of the following advantages: a modular air supply system with multiple operational modes; a simple air supply system that accommodates customization of modules to meet operational requirements; a low profile system to support confined space operations, the ability to carry more than one type of gas, the ability to switch from filtered air to self-contained air on demand. Other advantages are contemplated.

The details of one or more embodiments are set forth in the accompanying drawings and the description below. Other features, objects, and advantages will be apparent from the description and drawings, and from the claims.

### DESCRIPTION OF DRAWINGS

FIG. 1 is a front view of an exemplary embodiment of the present invention.

FIG. 2 is back view of an exemplary embodiment of the present invention.

FIG. 3 is a side view of an exemplary embodiment of the present invention.

FIG. 4 is an exploded view of the high pressure console of an embodiment of the present invention.

FIG. 5 is an exploded view of the manifold of an embodiment of the present invention.

FIG. 6 is a diagram of an electrical system of an embodiment of the present invention.

FIG. 7 is an embodiment of the present invention with two air cylinders, the center cylinder removed with no filter or blower motors attached.

FIG. 8 is an embodiment of the present invention with the blower motor in line with filter on the center assembly.

FIG. 9 is an embodiment of the present invention with the blower motor at the top of the center assembly.

FIG. 10 is an embodiment of the present invention with a blower motor at the top of the center assembly without filter attachments.

### DETAILED DESCRIPTION

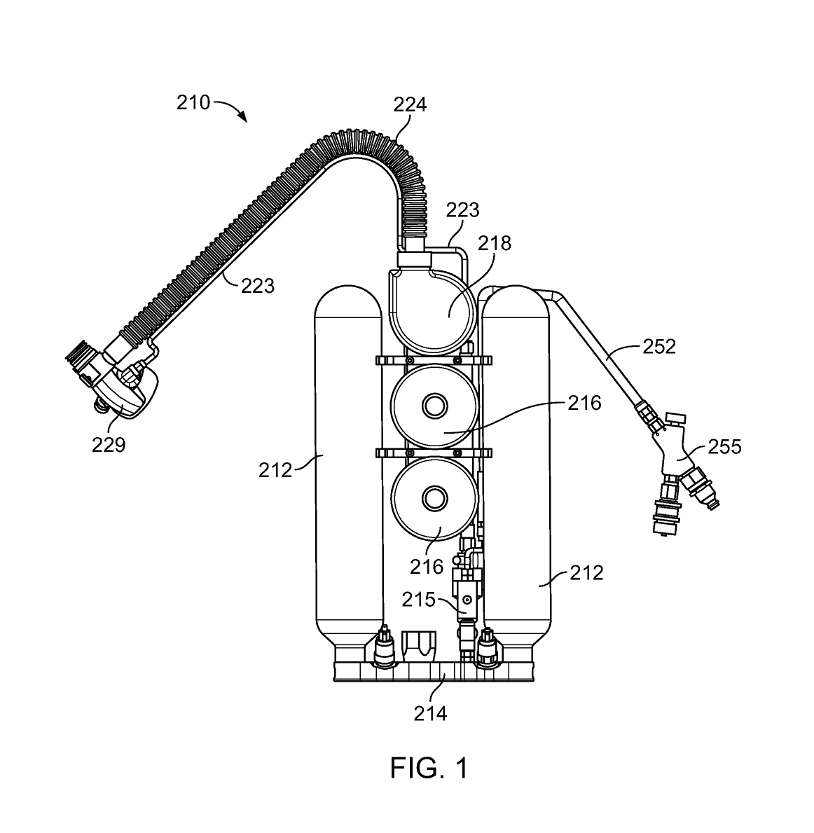

With reference to FIG. 1 a compact, low profile, multi-use breathing apparatus 210 includes air cylinders 212 connected to frame manifold 214, air filters 216, blower motor 218, high pressure console assembly 255, high pressure hose 252, low pressure air supply hose 223, blower hose 224, and regulator/filtered air supply assembly 229. In one operational embodiment, the breathing system 210 supplies filtered air as an Air Purification Respirator (APR) wherein ambient air is drawn by the user through filters 216 and delivered through blower hose 224 to regulator/filtered air supply assembly 229. Alternately, the breathing system 210 supplies air as a Powered Air Purification Respirator (PAPR) wherein filtered air is drawn through air filters 216 by blower motor 218 and delivered through blower hose 224 to regulator/filtered air supply assembly 229. In a further alternate operational mode, breathing system 210 supplies air as a Self-Contained Breathing Apparatus (SCBA) by supplying self-contained air drawn from one or more air cylinders 212 through manifold 214 to high pressure reducer 215 via low pressure air supply hose 223 to regulator/filtered air supply assembly 229. In still a further operational mode, breathing system 210 provides air as a Supplied Air Respirator (SAR) by drawing pressurized air through a connection at console assembly 255 via high pressure hose 252 and into high pressure reducer 215, through low pressure supply hose 223 to regulator/filtered air supply assembly 229.

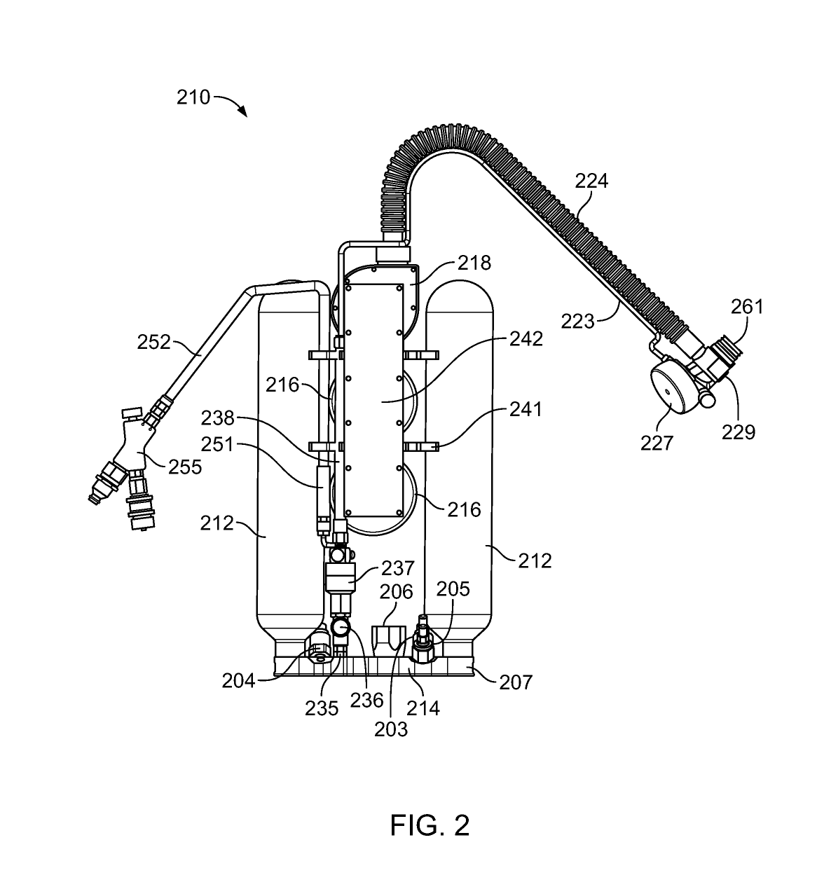

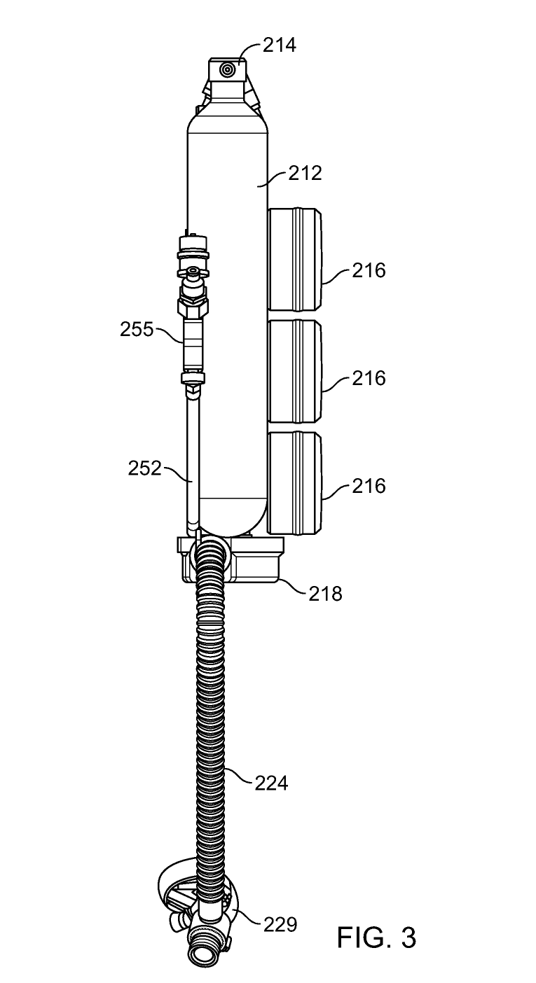

FIGS. 2 and 3 show an exemplary embodiment of breathing system 210 with a center air cylinder 212 removed. Cap 206 can be secured to manifold 214 when a cylinder is removed to maintain a closed environment and prevent leakage of air through the cylinder connection 207. Manifold 214 can include various auxiliary components including low pressure alarm 204, high pressure relief disk 205, and low pressure mechanical switch 203. Low pressure alarm 204 can be a mechanical, pneumatic or electronic alarm and can be set at any pressure level to indicate a low pressure level (e.g., system air pressure levels below 1500 psi, 1400 psi, 1300 psi, 1200 psi, 1100 psi, 1000 psi, 900 psi, 800 psi, 700 psi, 600 psi, 500 psi, 400 psi, 300 psi, 200 psi or 100 psi.) Multiple alarm conditions can be set using one or more alarms. Alarms can include audible alarms (e.g. whistles, buzzers, beeps, or chimes), visual alarms (e.g., lights, LEDs, flags, or Barbour pole indicators), or vibratory alarms.

Manifold 214 discharges pressurized air through discharge port 235, which is connected to and in fluid communication with on/off valve 236, high pressure reducer 237 and low pressure interface hose 238. High pressure reducer 237 acts as a first stage regulator and includes a high pressure side and low pressure side. Also in fluid communication with the high pressure side of the high pressure reducer 237 and the manifold 214 is high pressure hose assembly 252, which in turn is connected to and in fluid communication with high pressure console assembly 255. This arrangement allows pressurized air from an external source to be supplied to the breathing apparatus 210 and delivered to the user or recharge the pressurized air cylinders 212. Low pressure interface hose 238 is connected to and in fluid communication with low pressure air supply hose 223 and low pressure, second stage demand regulator 227. In some embodiments, low pressure air supply hose 223 is helically wound around filtered air supply hose 224.

In embodiments, low pressure interface hose 238 can run along or be secured to air filter mounting bracket 241 and high pressure hose assembly 252 can also be secured to air filter mounting bracket 241. Air filter mounting bracket 241 and air filter mounting manifold 242 can provide structural support to the fully assembled breathing apparatus 210. One or more air filters 216 are attached to air filter mounting manifold 242 via air filter connection 217 (not shown). Blower motor 218 also connects to air filter mounting manifold 242. In embodiments, blower motor 218 and air filters 216 can connect to any available connection 217. When a blower motor or air filter is not connected to connection 217, the connection can be secured with a filter connection cap, 219 (not shown) in order to preserve a closed system. It will be appreciated that any number of arrangement of one or more filters with or without the blower motor can be assembled using the filtered air manifold and various air filter connections. For example, three filter cartridges and the blower motor can be connected. Two filter cartridges and the blower motor can be connected. One filter cartridge and the blower motor can be connected. Three filter cartridges can be connected with no blower motor attached. The blower motor can be attached without any filter cartridges.

Filtered air supply hose 224 can connect directly to blower motor 218, which in turn draws air from the filtered air manifold 242. In embodiments of the present invention, the filtered air supply hose 224 can connect directly to the filtered air manifold 242. Filtered air supply hose also connects to the air supply assembly 229 by a barbed hose connection or other standard hose connection. Air supply assembly 229 includes low pressure, second stage demand regulator 227, filtered air supply hose connection 260, and mask connection 261. Mask connection 261 can be a quick connection, such as the NATO standard mask quick connection.

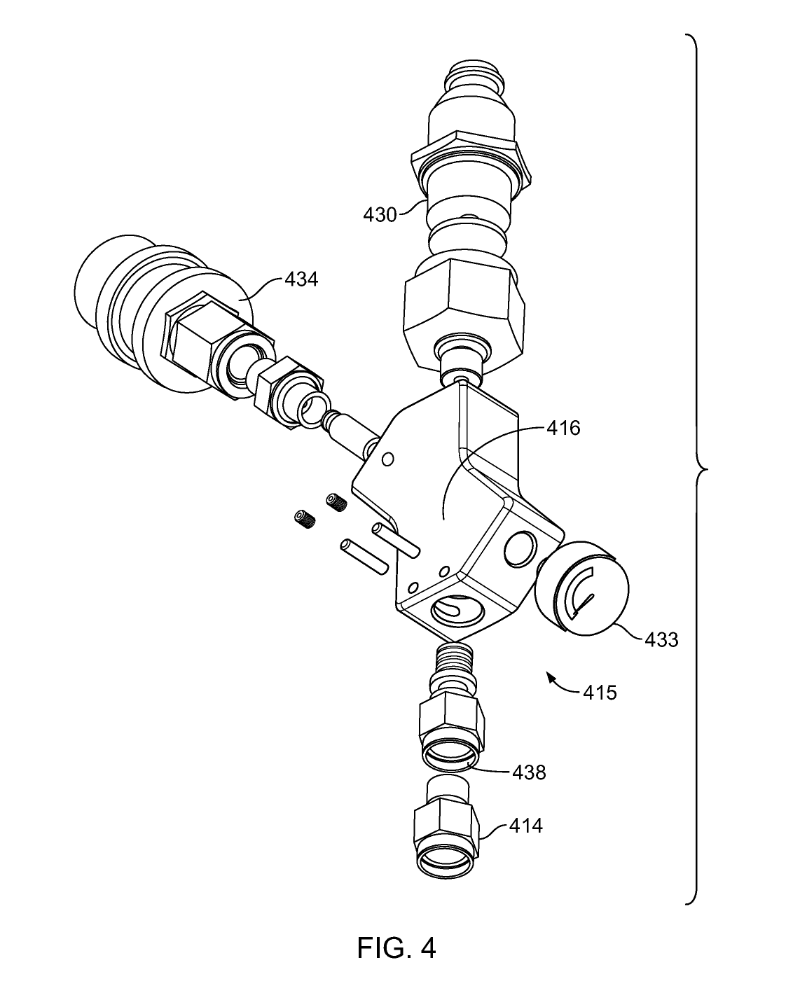

With reference to FIG. 4, the high pressure console assembly 415 includes a manifold block 416, a high pressure female quick disconnect 430, a high pressure male quick disconnect 434, high pressure hose assembly 414 with swivel connector 438, and high pressure gauge 433. It will be appreciated that console assembly 415 can include additional pressure connections and/or hose connections for multiple sources of discharge and supply to and from the contained air manifold of the system.

In one operational embodiment of the present invention, the pressure cylinders of the system can be refilled or recharged using pressurized air from and external source connected to either the high pressure female quick disconnect 430 or the high pressure male quick disconnect 434. The external source of air can be from the tank of a second breathing apparatus. Indeed, it is contemplated that two or more breathing apparatus can be connected using the high pressure console assembly 415 to accommodate buddy breathing, recharging of spent cylinders, or delivery of medical oxygen as described below. In embodiments of the present invention wherein the use of pure oxygen is contemplated, manifold 214 is constructed from stainless steel. When pure oxygen is not contemplated, manifold 214 can be constructed from stainless steel, titanium, aluminum, brass, composite materials or any other suitable material.

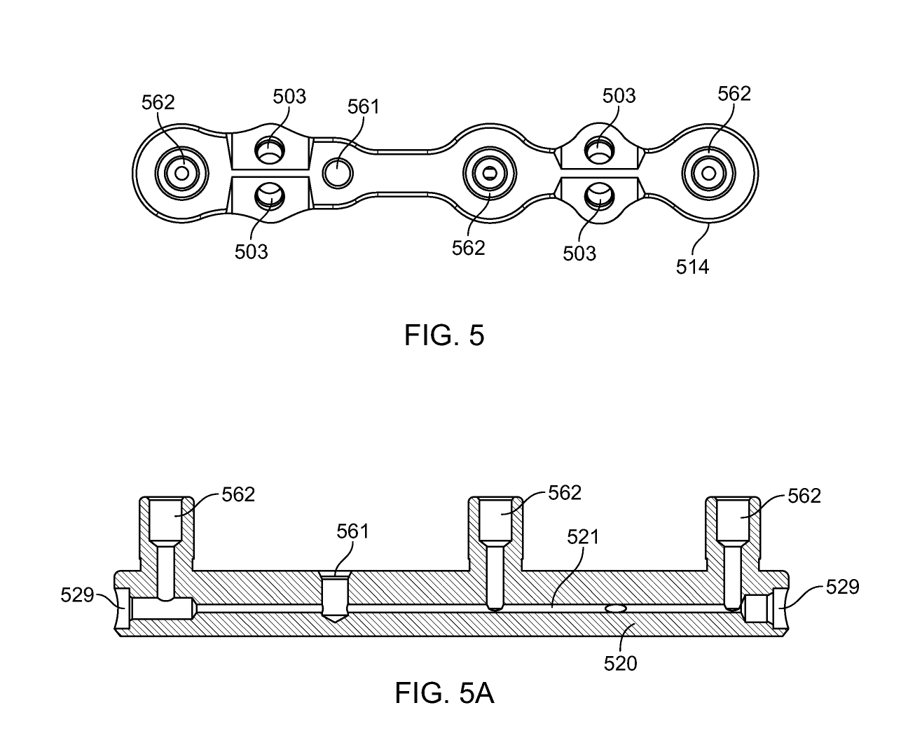

Referencing FIGS. 5 and 5A, the contained air manifold 514 includes manifold block 520, compressed air passageway 521, cylinder connections 562, manifold discharge 561, manifold caps or plugs 529, and ports 503 for mechanical switches, alarms and high pressure relief disks.

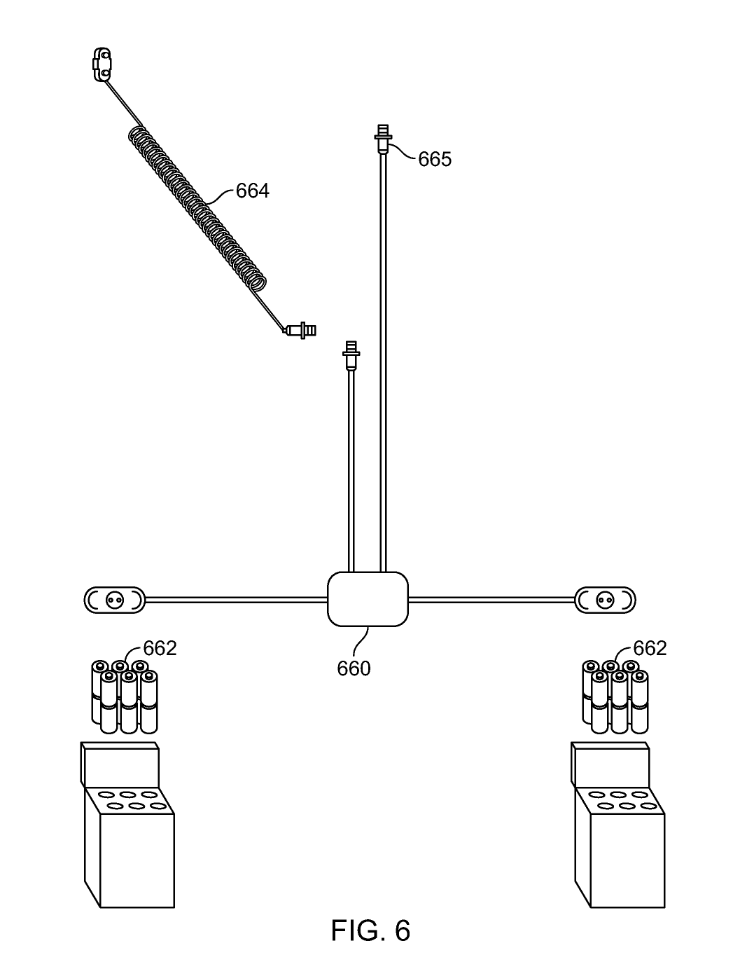

In embodiments, the electrical system of the breathing apparatus can be powered by the power supply associated with the blower motor used in the PAPR operational mode. Referencing FIG. 6, electrical connection circuit board 660 is connected to one or more power sources or batteries 662, a releasable on/off switch 664 and the blower mower motor 665. Other electrical devices such as monitors, communications equipment, navigational equipment, and environmental sensors can be connected to the electrical system. In an exemplary embodiment, the electrical system and power supply is dedicated to the blower motor. The battery or power supply can be any standard battery size, and in embodiments supplies electrical power to the blower motor for up to 12 hours or more (e.g., 1-2 hours, 2-3 hours, 3-4 hours, 4-5 hours, 5-6 hours, 6-7 hours, 7-8 hours, 8-9 hours, 9-10 hours, 10 or more hours).

The apparatus itself may include the following parameters, which are adjustable depending on the configuration of the system. The apparatus includes a length of about 18 to 24 inches (e.g., about 19 inches, 20 inches, 21 inches, 22 inches, 23 inches or 24 inches) from top to bottom when placed on a user. The system also includes a width of about 10 to 14 inches (e.g., about 11 inches, 12 inches, or 13 inches). The system may be placed in a backpack to create a depth of about 4 to 8 inches (e.g., about 5 inches, 6 inches or 7 inches) with PAPR and filters, or about 3 to 5 inches without PAPR and filters.

The disclosed system may have a volume of about 1400 to 1600 cubic inches (e.g., about 1450, 1500, or 1550 cubic inches) with PAPR and filters, or a volume of about 900 to 1100 cubic inches (e.g., about 950, 1000, or 1050 cubic inches) without PAPR and filters. These dimensions result in a weight for the system with the backpack of about 20 to 30 pounds (e.g., about 21, 22, 23, 24, 25, 26, 27, 28 or 29) pounds, which is much lighter than conventional respiratory protection systems. The system along with the backpack also may be worn on the front of an operator without significant drawbacks.

These dimensions and weight allow an operator to negotiate tight spaces and crawlspaces or to move about quietly without banging the system against walls and the like. It also allows an operator to use the system for extended periods of time without significant fatigue. Further, an operator may put the system on quickly and without the need for a second party to waist with attaching hoses, filters, and the like. The system also attaches to any face mask with a standard fitting, such as for example a 40 millimeter female thread, as long as a spring-loaded air outlet valve is present.

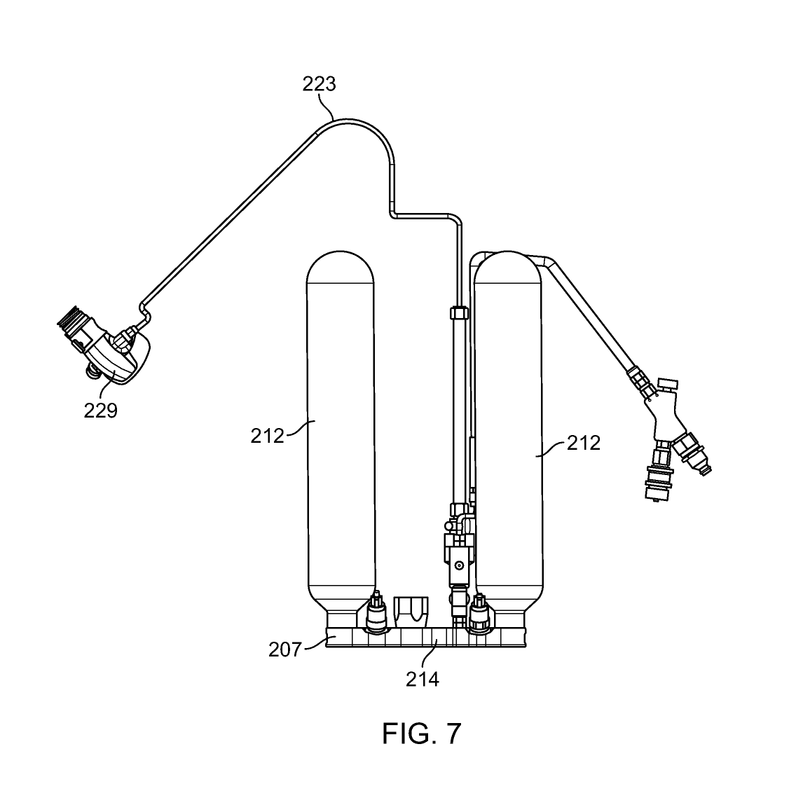

In embodiments, the disclosed system includes one or more bottles of self-contained air. The system may use 1, 2 or 3 or more bottles as needed. FIG. 7 depicts an embodiment of the present invention having 2 bottles, the center bottle removed, with no filter or blower motors attached.

The bottles or cylinders can have a volume of between about 110 to 130 cubic inches (e.g., about 115, 117, 119, 121, or 123 or more cubic inches). The bottles or cylinders can be any standard pressure vessel. In embodiments, the cylinders can be aluminum, carbon-wrapped cylinders. Each bottle or cylinder may include about 15 to 25 cubic feet (e.g., about 16, 17, 18, 19, 20, 21, 22, 23, or 24 cubic feet) of compressed air for a total capacity of between about 45 and 75 cubic feet when three bottles are used. Weight of the air at full charge is about 5 pounds. These parameters allow an operator to have about 45 minutes of breathing time at a moderate work rate, such as 40 liters per minute (LPM).

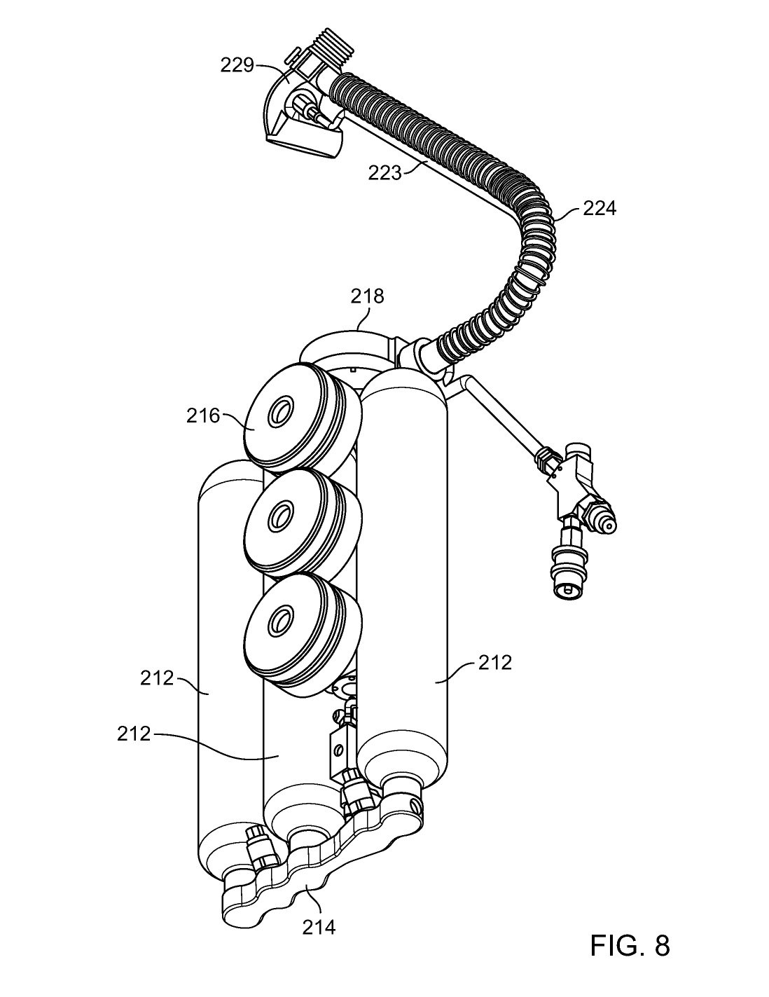

In an embodiment of the disclosed system, and with reference to FIG. 8, a center module slides between the bottles to secure them. The center module also includes attachments for three filters. The filters allow a breathing rate of filtered air of about 64 liters per minute. Two filters are needed to meet standards for respiratory protection and desired filter flow arrangements. The filters are detachable and easily accessible for replacement or maintenance. An operator can arrange the filters on the center module into any desired configuration and is not limited to the configuration shown. For example, an operator may want one filter at the top of the center module for easy access over the shoulder.

The embodiments also may include a brushless blower motor that enhances reliability and longevity. The motor can be battery powered, at about 15 volts. The battery or batteries can provide a duration of about 8 hours or more. A quick-changeout battery holder secures the batteries in place. In an embodiment, the disclosed motor uses 5 three-volt batteries, but the preferred embodiments are not limited to this configuration, number or types of batteries, or power settings. Batteries may be designed to be isolated from the breathing system so as to be replaceable in a contaminated environment. In embodiments, the battery or batteries may only feed the motor without supplying other parts of the disclosed system.

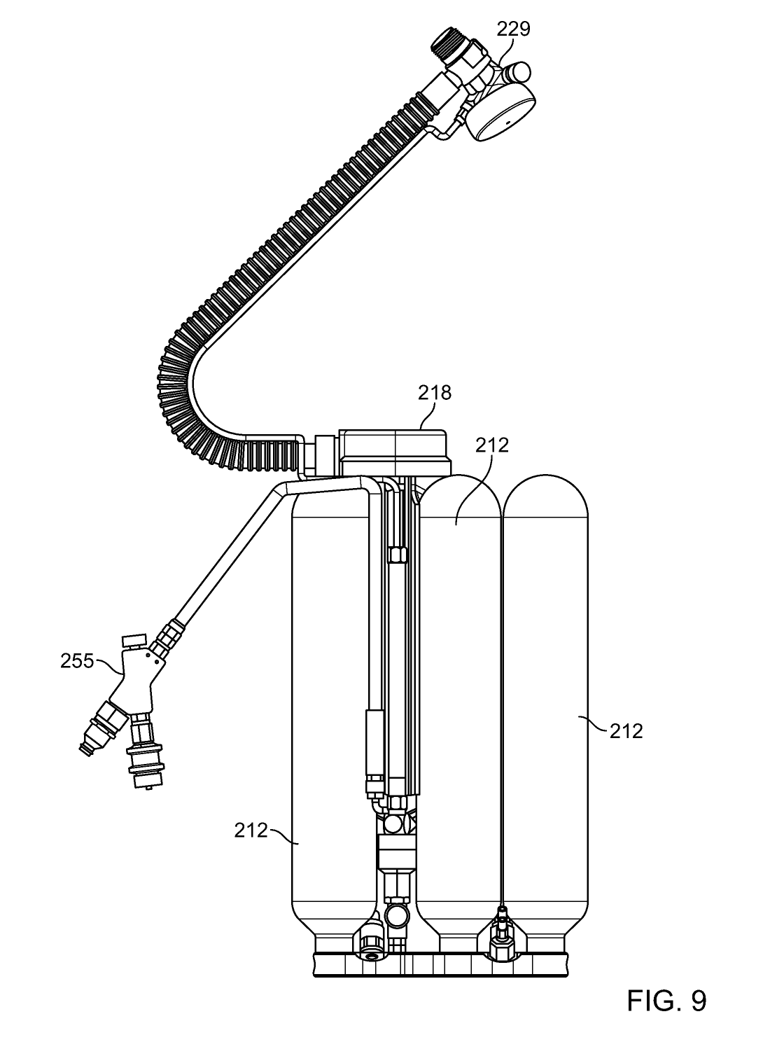

The motor can be located on the top of the center module or in line with the filter, as disclosed in FIG. 8 and FIG. 9 respectively. Further, the motor may be stand-alone or detachable from the center module, or even movable to any desired location along the center module. Such flexibility allows an operator to keep the motor in a position that is accessible to him in case of emergency or maintenance.

The flexibility with the placement of the filters and the motor (if applicable) permits the operator to maintain a low profile with the disclosed system. The disclosed system may fit into a backpack and not have unwieldy protrusions to knock against fixtures or other items and to fit into smaller spaces than conventional respiratory protection systems. Further, the motor may make noise while in use, and can be located inside the backpack to reduce such noise.

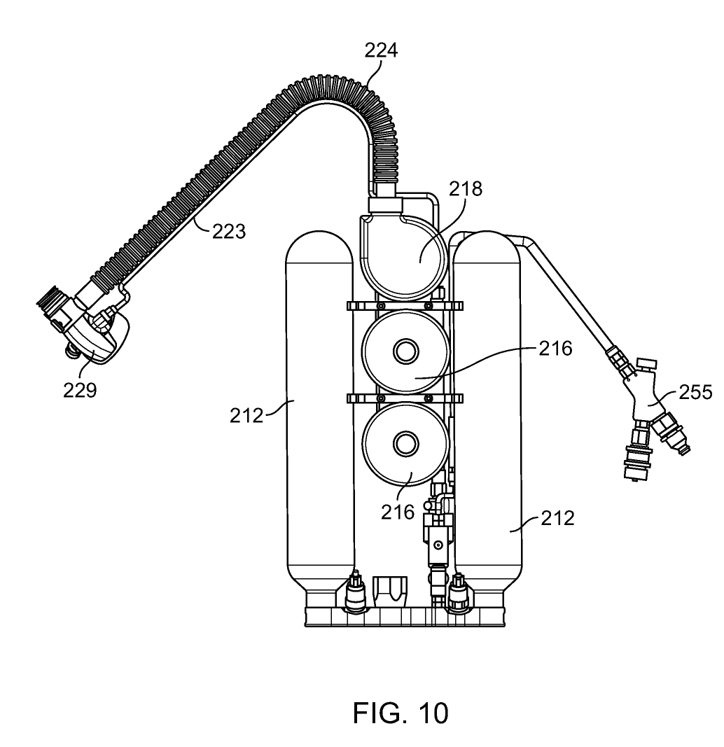

The PAPR system of the disclosed embodiments may be removable from the base system. Thus, the disclosed system may convert to a lower profile or to an air-only system, as depicted in FIG. 10. With the air-only system, the size and weight are reduced for easier use.

The disclosed system also includes regulators to supply the operator with air from the cylinders at ambient pressure. The regulators may configure one or more valves in a series to lower air pressure at each stage. For example, a first stage regulator may reduce the air pressure from about 4500 psi to about 80-150 psi, using one valve for on/off to feed the regulator with the compressed air. In another embodiment, the first stage regulator reduces the air pressure from about 6000 psi to about 80-150 psi. Thus, the first stage regulator converts the pressurized contained air into breathable air. In embodiments the first stage regulator comprises a stainless steel regulator, nickel plated aluminum regulator, titanium or bronze, which is able to withstand high pressures, heat, water and wear/tear associated with hazardous operations.

A second stage regulator also may be included that eliminates or bypasses the filters and feeds low pressure air to the operator. The second stage regulator may be located on the low pressure side of the high pressure reducer. The dual regulator configuration allows the operator to switch the disclosed system between pressurized air supplied from the self-contained air cylinder or pressurized air from an external source and filtered air, either powered or unpowered. Switching between such modes of operation can be done quickly and quietly.

The regulators may incorporate high-performance, lightweight, balance piston or unbalanced piston lung-demand valves. The regulators may deliver in approximately between 500 and 700 (e.g., about 550, 600, 650, or 700) liters per minute of air, thereby supplying all the air necessary to an operator even under the most strenuous working situations. The regulators may be extremely quiet, positive pressure systems that are activated on the first breath. In embodiments, at least one of the regulators may incorporate a demand valve that detects when the operator starts breathing and supplies ambient air.

A donning button permits the regulator to be in stand-by mode for quick activation when needed. An operator may switch to this mode by using the second stage regulator in a quiet manner. Once the operator takes a breath, the regulator leaves stand-by mode and supplies air. The regulator may detect pressure from the PAPR configuration and ceases to free flow the air from the second stage regulator. The second stage regulator pressurizes the mask until it is shut off.

The disclosed regulators also use an ergonomic design that allows an operator to easily connect and disconnect from a mask attached to the disclosed systems. The regulators also may incorporate a check valve acting as an on/off switch. Moreover, the breathing system includes a safety feature that can activate automatically at the occurrence of specified events, such as an operator falling overboard or into water while unconscious or unable to switch between modes, or the obstruction of APR or PAPR air flow.

Charging ports may be located over-the-shoulder or on the waist using a quick-connect male/female connector. The connectors preferably are double-female quick-connect fittings. These may be provided with each system for buddy rescue/charging.

The disclosed systems also may include low pressure alarms to alert the operator when a low pressure condition exists. A pressure sensor connects to a high pressure regulator to alert the operator that an emergency is imminent. The disclosed system may incorporate a variety of alarms. One alarm may be a 70 psi whistle, preferably at about 90 decibels. Alarm whistles can be set at any pressure level depending on the needs of the operator. Another alarm may be an external LED indicator that provides a non-audible alert to the operator. Yet another alarm may vibrate within the mask connected to the disclosed system, straps of the mask, or dedicated neck strap, so that no light or sound is made during an alarm condition. The alarms are coupled to a pressure gauge or sensor that connects to the over-the-shoulder or waist-charging, quick connect fitting. Alternatively, the pressure sensor may be coupled to the high pressure regulator.

In PAPR/APR modes, the inhalation hose attaches between the second stage regulator and the mask. As disclosed in greater detail below, the disclosed embodiments may switch from filter mode to compressed air during emergency situations.

The disclosed system may utilize at least four configurations. The disclosed embodiments, however, are not exclusive to these configurations, and may include additional configurations. These configurations are discussed in greater detail, but the disclosed system is not limited to these configurations, and may be configured in any way available to those skilled in the art. The different configurations may correspond to mission requirements or needs as to respiratory protection.

### SCBA Configuration Embodiments

In embodiments of the present invention, the SCBA configuration is the basic configuration format in that it acts as a self-contained breathing apparatus. The SCBA configuration may be the least complex of all the systems. As such, this configuration is intended for confined space operations or limited-duration hostile environment operations.

The SCBA configuration uses one, two or three or more high-pressure cylinders with first and second stage regulators to supply air to an operator. This configuration also uses a pack carry system. The SCBA configuration may not have any PAPR or APR capabilities. The SCBA configuration uses up to three or more cylinders of air, as disclosed above, to provide between 21 and 85 cubic feet of total air. In an embodiment of the present invention, three cylinders of contained air can provide 63 cubic feet of total air at 4500 psi. The system also has an air storage capacity of about 1791 liters at about 4500 psi and air duration of about 45 minutes at 40 lpm. Some embodiments of the present invention include storing the compressed air at about 6000 psi or higher.

As the basic unit, the SCBA configuration does not utilize filters or oxygen (O₂) storage for medical or breaching purposes. Cylinders of different gases, however, can be switched out as needed. In embodiments, the SCBA configuration is not limited to only three cylinders of breathable air, but could provide cylinders of different gases, such as welding gases, medical gases, or other industrial gases (e.g., nitrogen, helium, oxygen, acetylene, mixed gases and the like).

The physical parameters of the SCBA configuration are an improvement over the heavy, bulky conventional respiratory protection systems. In exemplary embodiments the SCBA configuration includes a length of about 21 inches and a width of about 12 inches. It also includes a “depth” of about 4 inches such that the disclosed system only protrudes outwards that much, which is well under 6 inches. The SCBA configuration has an air-only weight of about 5 lbs and a system weight of about 21 lbs without a backpack and about 23 lbs with a backpack.

Other embodiments of the SCBA system can include the following features: stand-alone backpack; ballistic plate carrier/pack integration; high pressure blow-out protection; low pressure regulator relief valve protection; CBRNE hardened; filter isolation capability; cylinder recharge capability with quick-connect; low pressure alarm capability; 40 mm PAPR/APR compatibility; decontamination filter and fitting; low pressure auxiliary connection; double-male recharge fitting; and a charging hose (about 6 feet), bleed and gauge arrangement. Some or all of these features may be optional and are not required in the SCBA configuration for operations.

### Hybrid Configuration A

The disclosed embodiments can also include a hybrid configuration A (HCA). The HCA configuration combines a maximum use of contained air supply with a PAPR capability to operate in a PAPR mode. The HCA configuration includes the option of operating “un-powered” as an air purifying respirator (APR) mode for extended mission requirements. The HCA configuration also can operate in a supplied air respirator (SAR) mode depending upon available mission support elements. These various modes of operation result in the HCA configuration being the most capable configuration for hostile environment operations.

The HCA configuration uses the three cylinder configuration, as disclosed above with the SCBA configuration. The HCA configuration also includes 1, 2 or 3 filter capability and a positionable blower motor, as disclosed above. In embodiments, the motor is positioned on the top or rear of the system.

The physical parameters for the HCA configuration are compatible to those of the SCBA configuration, except that the HCA configuration weighs slightly more. In an exemplary embodiment, weight without the backpack is about 22 lbs while the weight with the backpack is about 24 lbs. The HCA configuration also includes all the features of the SCBA configuration along with APR (negative pressure filtration) and PAPR options. The HCA configuration also includes filter isolation capability and a first-breath activated regulator, as disclosed above.

### Hybrid Configuration B

The disclosed embodiments also include a hybrid configuration B (HCB) that provides for all four respiratory operational modes of the HCA configuration. The HCB configuration, however, also allows for a lower overall physical profile by removing 1 high pressure cylinder. This difference reduces the available contained air by about 33%. The space formerly reserved for the air cylinder may now be used for storage of all PAPR components inside the carry/back pack. Thus, the filters and motor of the PAPR mode are hidden inside the pack.

The HCB configuration is the lightest of the disclosed configurations and is ideal for missions requiring minimal equipment weight and a short mission time period, or those missions requiring a hidden or reduced physical profile while still providing maximum system versatility. Thus, the HCB configuration uses 1 or 2 air cylinders and 1 or 2 filters. Air storage capacity for the HCB configuration is about 1194 liters and air duration of about 30 minutes at 40 lpm.

The weight for the HCB configuration is lighter than the above-disclosed configuration due to the absence of the third cylinder. Thus, the air-only weight for this configuration is about 3.4 lbs. System weight without the backpack is about 19 lbs while the weight with the backpack is about 21 lbs. The HCB configuration also includes all the features of the HCA configuration, including the PAPR and APR features.

### Hybrid Medical/Breaching Configuration

The disclosed embodiments include a hybrid medical/breaching configuration (HMBC). The HMBC configuration is optimal for specific missions for medical or breaching purposes. It replaces one or more high-pressure oxygen cylinder for one or more of the air cylinders, or is added in addition to one or more of the air cylinders with a high-pressure oxygen cylinder. The oxygen cylinder provides oxygen, or O₂, for use in medical operations or as fuel for exothermic cutting apparatus. The HMBC configuration includes the tools and accessories required for both functions. This configuration retains the same respiratory capabilities of the HCB configuration but adds the extra capabilities of the compressed oxygen. The HMBC configuration may be the most versatile of the disclosed configurations.

The parameters of the HMBC configuration resemble the HCB configuration for breathable air, and using PAPR and the like modes. The HMBC configuration, however, also includes a cylinder of compressed oxygen that provides the gas at about 15 lpm for about 30 minutes. The oxygen storage includes about 390 liters at 3000 psi. The HMBC configuration also uses 1, 2 or 3 filters.

The air and oxygen combined weight is about 4.7 lbs. The total system weight without the backpack is about 22 lbs and about 23 lbs with the backpack. The other features of the HMBC configuration correspond to those with the HCB configuration.

The breaching option system of the HMBC configuration also may be known as a silent entry torching system (SETS). This option centers on the use of exothermic cutting torch technology and allows an operator to make use of either a conventional rod-style cutting torch or select the use of a cable-style cutting torch. The choice of cutting options is simple due to a user-friendly quick-disconnect. The disclosed system also includes a 12 volt electrical ignition option and also can make use of pyrophoric ignition options as well for either the rod or cable configuration.

The third cylinder configurations also may include one that places a medical oxygen supply cylinder into the disclosed system. This cylinder may be used for medical purposes as opposed to a torch system. Medical operators could deliver O₂ or other gases to personnel as needed. In high altitude situations, a different gas mix for this cylinder may be included in case the other cylinders become compromised. In another scenario, at high altitude for example, when the operator drains the two breathing cylinders, but the altitude does not allow for filtered air to be drawn into the disclosed system, this extra cylinder may be accessed.

The above-disclosed configurations and features are modifiable “in the field” by operators using a limited number of tools and with minimal training Changes do not require operators to report back to a depot or maintenance location, but can be done while embedded in a hostile environment. Thus, the disclosed system provides more flexibility than conventional respiratory protection systems.

The disclosed embodiments include the various special features and capabilities across all of its configurations. For example, all configurations automatically switch from PAPR/APR mode to SCBA mode if air flow through the PAPR/APR filters (1, 2 or 3 filter configuration) becomes blocked or flooded. In the filter mode, the inhalation hose attaches between the second stage regulator and the mask. The second stage regulator will not react until the filters become blocked or clogged, thereby engaging a diaphragm with pressure that switches over to compressed air for breathing.

An example of this situation is where the disclosed system becomes partially or totally submerged in water during maritime operations. This feature ensures continued air flow to the operator should he fall overboard, through a hole, a room floods, or the like. The disclosed system also provides an operator with positive buoyancy should the operator be forced to enter a water environment. This feature enables the disclosed system to serve as a secondary personal flotation device.

The disclosed embodiments support a low physical profile, which makes them ideal for confined space rescue operations. The operational versatility and durability also makes the disclosed system advantageous for Special Forces and para-rescue operations or tactical law enforcement operations. The carry-pack system is adaptable to interconnect and operate in association with several makes and models of personal tactical armor systems. In embodiments, the disclosed system can adapt to those personal protection units already in place, and does not require a large retrofit of existing equipment.

Even with the backpack or carry pack option, the disclosed system can be front-mounted, or placed in front of the operator. This feature allows for use in military parachute operations. An operator can move the pack to his/her front when needed. While back-mounted, the disclosed system allows an operator to drive, sit in, or use equipment in a ground or airborne vehicle and access breathable air. One may do this without major discomfort or having to lean forward. Thus, continuous breathable air is provided while in the middle of operations on such vehicles.

Thus, the disclosed embodiments provide a respiratory protection breathing system and associated device to allow more flexibility, lighter weight, adaptability, low maintenance and a more durable product to the operator in hostile environments.

The present invention has now been described with reference to several embodiments thereof. The foregoing detailed description has been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

What is claimed is:

1. A breathing apparatus comprising:
one or more contained air cylinders connected to a supply manifold;
a contained air supply hose connected to the supply manifold;
one or more air filters connected to a filtered air manifold;
a blower motor connected to the filtered air manifold;
a filtered air supply hose connected to the filtered air manifold; and
an air supply assembly connected to both the contained air supply hose and the filtered air supply hose for delivery of pressurized contained air, filtered air, or powered filtered air.

2. The breathing apparatus of claim 1 wherein the pressurized contained air is supplied on demand if the filtered air supply pressure is reduced, compromised or obstructed.

3. The breathing apparatus of claim 1 wherein the air supply assembly comprises a regulator connected to the contained air supply hose.

4. The breathing apparatus of claim 3 further comprising a high pressure regulator in communication with the supply manifold.

5. The breathing apparatus of claim 2 further comprising a high pressure assembly comprising a high pressure input connection and a high pressure output connection, wherein the high pressure assembly is in communication with the supply manifold.

6. The breathing apparatus of claim 1 wherein self-contained air is supplied to a second air supply assembly through the high pressure assembly.

7. The breathing apparatus of claim 1 wherein the contained air cylinders are recharged with high pressure air through the high pressure assembly.

8. The breathing apparatus of claim 1 wherein the air supply assembly is a sealable mask.

9. The breathing apparatus of claim 1 wherein at least one of the cylinders contains pure oxygen.

10. A modular breathing apparatus comprising:
a self-contained air module comprising one or more pressurized cylinders, a pressurized air supply hose, and a manifold connected to the one or more cylinders and the pressurized air supply hose;
a filtered air module comprising one or more air filtration cartridges, a filtered air supply hose and a filtered air manifold connected to the one or more filtration cartridges and the filtered air supply hose;
a powered air module comprising a blower motor connected to the filtered air manifold; and
an air supply assembly for delivery of pressurized air and filtered air to a user comprising a regulator connected to the pressurized air supply hose and a filtered air supply connection.

11. The modular breathing apparatus of claim 10 wherein the powered air module is replaced with a connection plug to provide only self-contained pressurized air or filtered air to the air supply assembly.

12. The modular breathing apparatus of claim 10 wherein the one or more filtration cartridges are replaced with one or more connection plugs to provide only self-contained pressurized air to the air supply assembly.

13. The modular breathing apparatus of claim 10 further comprising a high pressure regulator connected to the manifold and the pressurized air supply hose.

14. The modular breathing apparatus of claim 10, further comprising a high pressure assembly comprising a high pressure input connection and a high pressure output connection, wherein the high pressure assembly is in communication with the manifold.

15. The modular breathing apparatus of claim 14 wherein self-contained air is supplied to a second air supply assembly through the high pressure assembly.

16. The modular breathing apparatus of claim 14 wherein the pressurized cylinders are recharged with high pressure air through the high pressure assembly.

17. The modular breathing apparatus of claim 10 wherein at least one of the pressurized cylinders contains pure oxygen.

18. The modular breathing apparatus of claim 10 wherein the air supply assembly is a mask.

19. The modular breathing apparatus of claim 10 wherein pressurized air is supplied on demand by the user during reduced availability of the filtered air through the filtered air supply hose.

20. A modular breathing apparatus comprising:
a manifold having one or more cylinder connections, a manifold discharge, and one or more manifold ports;
a first pressurized air delivery system comprising;
a high pressure regulator in fluid communication with the manifold discharge;
a low pressure supply hose in fluid communication with the high pressure regulator,
a second stage regulator in fluid communication with the low pressure supply hose;
a second pressurized air delivery system in fluid communication with the manifold discharge and the high pressure regulator of the first pressurized air delivery system, the second pressurized air delivery system comprising a pressure hose and one or more quick connection fitting at the terminal end of the pressure hose.

21. A method for providing air supply comprising:
providing self-contained air through a pressurized air manifold and pressurized air supply hose;
providing filtered air through a filtered air manifold and filtered air supply hose;
providing powered filtered air through a blower motor connected to the filtered air supply manifold; and
and switching between pressurized air and filtered air or powered filtered air wherein the switching is on demand by activation of a regulator upon reduced filtered air or powered filtered air supply.

22. A method of providing a modular breathing apparatus, comprising:
providing a pressurized air manifold with one or more sealable supply connections and one or more pressurized cylinders connected to the sealable connections, wherein the connection is sealed with a cap when a cylinder is not connected thereto;
providing a filtered air manifold with one or more sealable filter connections and one or more air filtration cartridge connected to the sealable filter connections, wherein the connection is sealed with a cap when a filtration cartridge is not connected thereto;
providing a blower motor connected to the air manifold at one of the sealable filter connections;
connecting a sealable mask to the pressurized air manifold wherein the connection includes one or more regulators;
connecting the sealable mask to the filtered air manifold; and
automatically switching between pressurized air supplied from the pressurized air manifold and the filtered air supplied from the filtered air manifold.
